(19) United States
(12) Patent Application Publication
(10) Pub. No.: US 2026/0045138 A1
(43) Pub. Date: Feb. 12, 2026

(54) Cross-platform Play System

(71) Applicant: Aristocrat Technologies, Inc., Las Vegas, NV (US)

(72) Inventors: Joseph Masinter, II, Las Vegas, NV (US); Melissa Lawres, Tallahassee, FL (US); Kirk Chapman, Franklin, TN (US); Kristian Soriano, Las Vegas, NV (US)

(21) Appl. No.: 19/294,078

(22) Filed: Aug. 7, 2025

Related U.S. Application Data
(60) Provisional application No. 63/681,036, filed on Aug. 8, 2024.

(51) Int. Cl. G07F 17/32

(52) U.S. Cl. CPC G07F 17/3225

(57) ABSTRACT

A system and technique for providing multi-platform gameplay is provided. A cross-platform gameplay server receives wager data from different platforms in different currencies. Based on a gaming outcome, the cross-platform gameplay server manages game play in different currencies to facilitate cross-platform gameplay. Exchange rates are determined between a universal currency and game play currencies, and reward data is stored by the cross-platform gameplay server in the universal currency. A user interface is provided for a gaming application on a first platform, which supports interaction with a remote player on a remote device using a second platform. A cross-platform play region is presented on a user face to provide interaction with remote players using a cross-platform functionality of an application.

### TECHNICAL FIELD

The field of disclosure relates generally to electronic gaming, and more particularly to systems and techniques for facilitating cross-platform gameplay across electronic gaming machines (EGMs) and online gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIGS. 3A-3B illustrate example network architectures for an example system for facilitating cross-platform gameplay between casino gaming environments and online game play.

FIG. 4 is a flow diagram of a technique for providing cross-platform gameplay, in accordance with one or more embodiments.

FIG. 5 is a flow diagram of an alternative technique for providing cross-platform gameplay, in accordance with one or more embodiments.

FIG. 6 is a flowchart of a technique for initiating cross-platform gameplay on an electronic gaming machine, according to some embodiments.

FIG. 7 shows an example cross-platform interface on an EGM, according to some embodiments.

FIG. 8 shows an alternative example cross-platform interface on an EGM, according to some embodiments.

FIG. 9 is a flowchart of a technique for initiating cross-platform gameplay on a mobile application, according to some embodiments

FIG. 10 shows an example cross-platform interface on a mobile application, according to some embodiments.

FIG. 11 depicts a flow diagram of a technique for cashing in cross-platform credit, according to some embodiments.

FIG. 12 depicts a flowchart of a technique for exchanging game assets using the cross-platform system, in accordance with one or more embodiments.

### DETAILED DESCRIPTION

A comprehensive connected solution for permitting social gaming players and casino slot players on different gaming platforms the ability to play games together across platforms (multiple casinos, multiple properties, online applications, and the like). The cross-platform server holds a database of player accounts along with their balance in a universal currency, which can be cashed out or redeemed for social currency. Their account also saves the credentials for logging into their player tracking account, the various social casinos, and iGaming apps, which serves as a way to link between their various accounts. EGMs are connected to the cross-platform server through the casino's casino management system (CMS).

Players can connect with other players through the cross-platform system (“CxPlay”). For example, casino players can connect with social-gaming players that are not physically playing in the casino, but rather playing social games via an igaming application on their phone.

Depending on the jurisdiction, CxPlay coins or other award can be exchanged for cash at the casino. To determine the exchange rate for CxPlay coins and their real-money cash value, exchange rate information obtained from social games that can be made available in CxPlay. For example, an application may provide players with defined coin redemption costs in USD to purchase coins in a currency specific to the application. The CxPlay server is provided with information on the ratio of USD to social credits for each online game available in the CxPlay ecosystem.

According to some embodiments, CxPlay coins have actual value as they can be exchanged for USD in a casino, converted to credit in the EGM, or used as social credits in any participating social games. Conversion of CxPlay coins from a cash value to social gaming credits is discussed within.

Techniques described herein address a technical problem of cross-platform interoperability of multiplayer applications, such as multiplayer games. Traditionally, electronic games and other applications operate in silos specific to different operating platforms such as mobile gaming, electronic gaming machines, online gaming, and the like. This fragmentation inhibits operation of a shared gaming environment to players on different types of devices. In addition, gaming assets, such as credits, rewards, opportunities, and the like are often different across different platforms.

Embodiments described herein provide a technical solution by providing a computing environment, for example in the form of a central server or cloud-based platform, for CxPlay which provides functionality supported by an application program interface (API) which acts as an intermediary between different gaming environments. In some embodiments, the CxPlay also provides improvements to a user interface to allow for augmenting a game interface to incorporate cross-platform content. Further, in some embodiments, the CxPlay architecture provides new data structures to support dynamic valuation of game assets from different games and platforms.

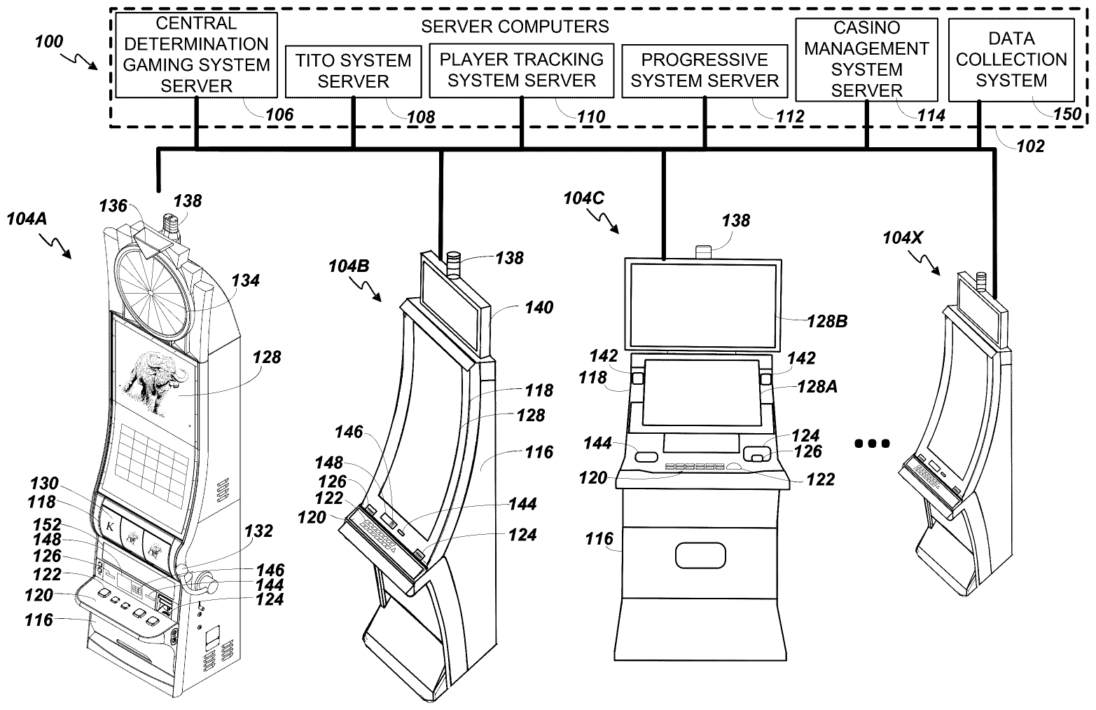

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards. Additionally, or alternatively, one or more of gaming devices 104A-104X may be configured as a tabletop game.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, a casino management system server 114, and/or a data collection system 150. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

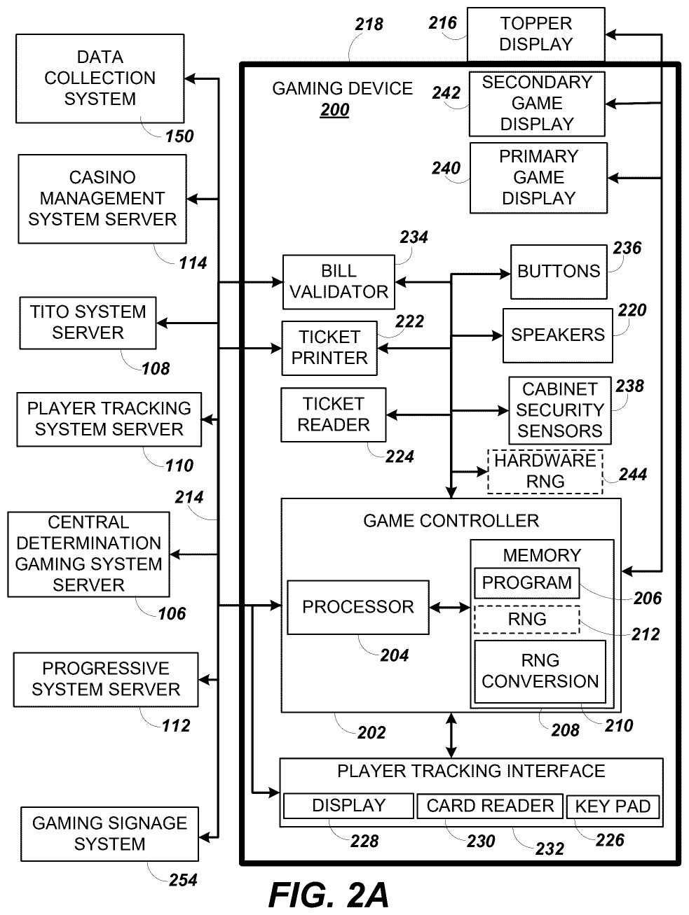

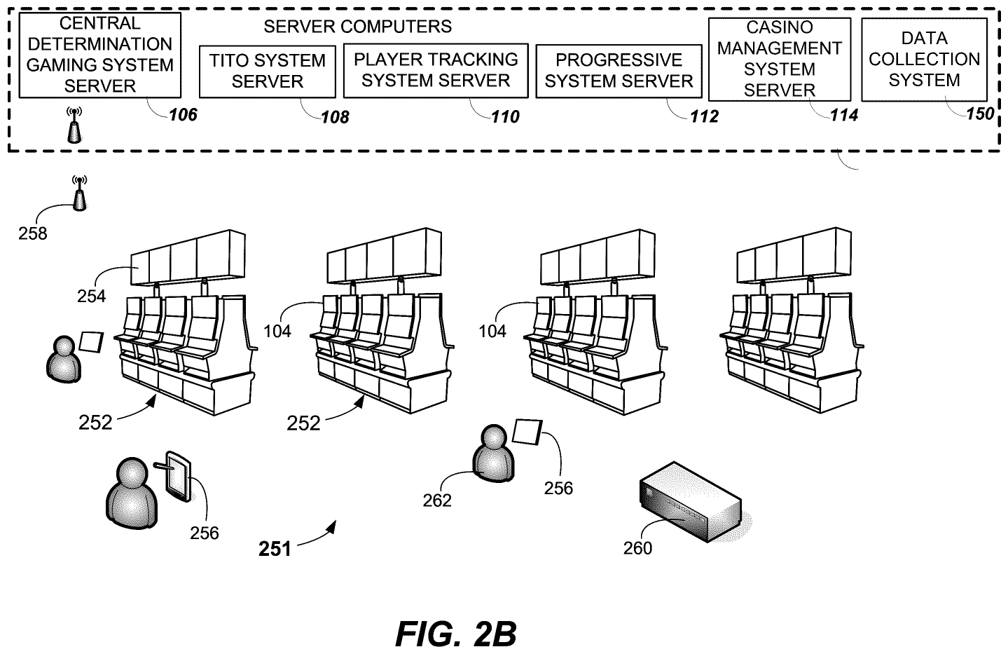

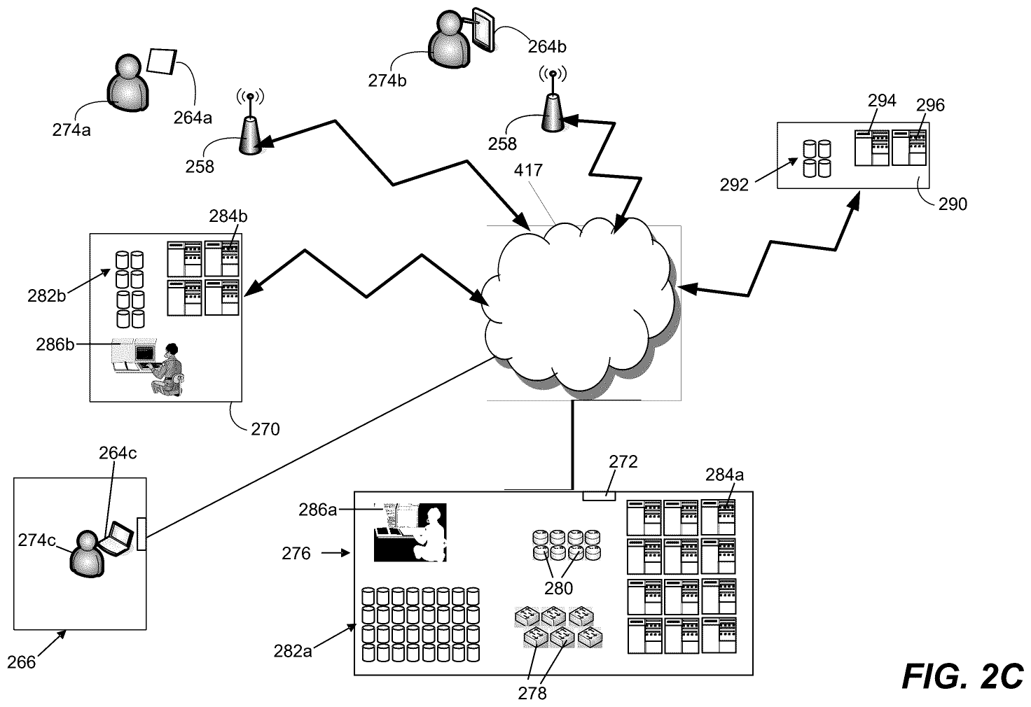

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Although gaming devices 104A-104X are shown in FIG. 1 as upright EGMs, the systems and methods described herein can be used on upright EGMs or table type EGMs.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

In an example embodiment, a tabletop EGM (not shown in FIG. 1) is provided which may be similar to the gaming devices 104. The tabletop EGM may include a horizontal display device that can be used by patrons as a conventional table surface as well as for providing player input (e.g., touchscreen surface, mechanical buttons, or the like) and display output (e.g., virtual wheel, virtual slot reels) for a tabletop game. The tabletop EGM may support participation for multiple players during game play (e.g., as patrons socially meet around the tabletop EGM). Example tabletop EGMs and features are described in greater detail below.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In some embodiments, a data collection system 290 is also configured for communication via the networks 417. Here, the data collection system 290 includes a collection server 294 and an authentication server 296. According to some embodiments the collection server is configured to store the collected data for later use, such as data analytics and the like. In some embodiments, the collection server 460 may be configured to facilitate storage of collected data in an additional network storage 292. The data collection system 290 also includes an authentication server 296, which provides authentication services for devices collecting data. In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

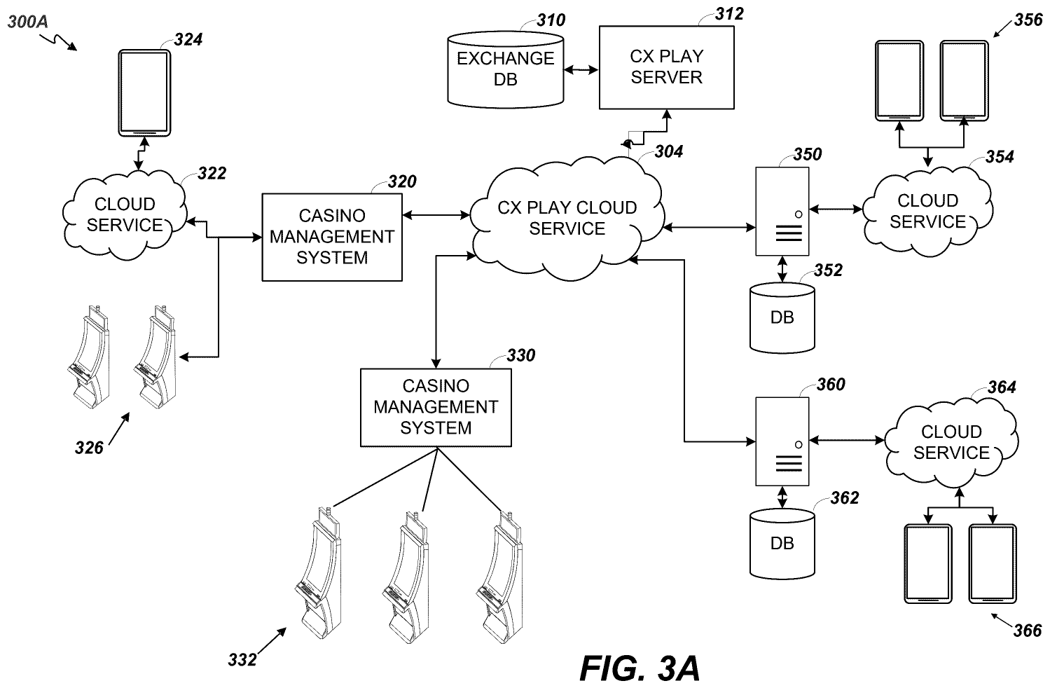

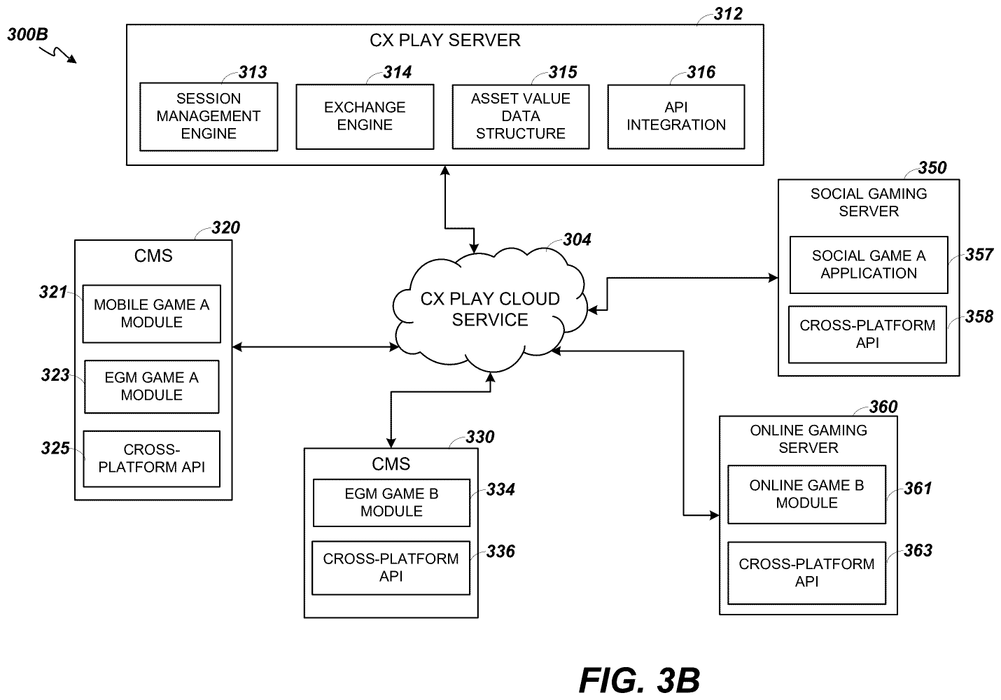

FIG. 3A is a networked architecture 300 for an example cross-platform gaming technique. In the exemplary embodiment, a cross-platform gaming server (shown as CxPlay Server 312) provides a system for allowing cross-platform game play. For purposes described herein, cross-platform gaming refers to a technique for allowing players of two games to interact with each other on different games (such as titles of games), or different platforms (such as device type). However, in some embodiments, the cross-platform gaming technique may also be used to allow users to interact with each other from two devices of the same platform, and/or from two games of the same title. In one example, CX Play Server 312 may be configured to bridge the gap between gaming experiences on different platforms, such as online and land-based gaming experiences, or land-based gaming experiences of different ecosystems, allowing for seamless interaction and currency exchange across different gaming environments. The CX Play Server 312 also manages user data by storing account information in exchange database 310. Exchange database 310 may be configured to store player account information, such as player credit in a universal currency, such as one specific to the cross-platform service. The CX Play Server 312 also handles the conversion of winnings from online or land-based gaming into the universal currency. This includes converting game-specific currencies into CX play currency and vice versa, enabling the use of winnings across different gaming platforms.

As shown in FIG. 3B, CX Play Server 312 may include various modules and components for managing cross-platform gaming functionality. For example, CX Play Server 312 may include a session management engine 313, an exchange engine 314, game asset ledger 315, and API integration 316. The session management engine 313 may administer creation, maintenance, and termination of concurrent gaming sessions across heterogeneous platforms. In some embodiments, the session management engine 313 may coordinate gaming sessions across multiple devices. Further, the session management engine 313 may manage asynchronous events received from the devices engaged in a multi-platform gaming session. Exchange engine 314 may determine and apply conversion operations among game assets. In some embodiments, exchange engine 314 may perform a lookup against asset value data structure 315, which may act as a repository for the value of different game assets against a universal asset. In some embodiments, the asset value data structure 315 may support dynamic valuation of gaming assets. Further, the asset value data structure 315 may maintain valuation data for monetary or credit assets, as well as other non-monetary awards or opportunities, such as free spins, feature game opportunities, and the like, such that a non-monetary award in one game and/or platform may be transferred to another monetary value or non-monetary award in another game and/or platform. In some embodiments, the exchange engine 314 may compute dynamic exchange rates across different games and/or platforms based on a tracked universal asset value in the asset value data structure 315. The CX Play server 312 may also include API integration 316, which exposes programmatic interfaces through which remote components can access the various components of the CX Play server 312.

According to one or more embodiments, the CX Play server 312 provides the cross-platform functionality over CX Play cloud service 304. CX Play cloud service 304 allows different computing systems associated with different platforms to communicate with each other via the CX Play server 312. For example, casino management system 320 may provide functionality for land-based gaming in a ecosystem corresponding to the casino management assistance 320. This may include, for example, electronic gaming machines 326, and/or virtual gaming provided across a cloud service 322, for example in the form of a mobile application 324. As shown in FIG. 3B, CMS 320 may include mobile game A module 321, which may include a version of “Game A” for mobile devices, and EGM Game A module 323, which may include a version of “Game A” for EGMs, for example in a casino or other land-based gaming environment. Each of these games may be configured to use the cross-platform API 325 which enables cross-platform communication by way of CX Play server 312.

Similarly, casino management system 330 may provide functionality for land-based gaming in an ecosystem corresponding to the casino management assistance 330, which may be different than the ecosystem supported by casino management system 320. This may include, for example, electronic gaming machines 332. Accordingly, the CX Play Cloud Service 304 may allow for interaction between users at EGMs 332 and users at EGMs 326 and/or application 324, even if CMS 320 and CMS 330 are associated with different platforms, such as different gaming providers, currencies, casinos, or the like. As shown in FIG. 3B, CMS 330 may include EGM Game B module 334, which may include a version of “Game B” for EGMs, for example in a casino or other land-based gaming environment. The EGM Game B module 334 may be configured to use the cross-platform API 336 which enables cross-platform communication by way of CX Play server 312.

The CX Play cloud service 304 may additionally support communication and interactive gameplay between land-based games and online or mobile games. For example, online gaming server 350 may support a particular online game or suite of games. In particular, online gaming server 350 may provide gameplay for online games over a cloud service 354, for example by hosting one or more gaming applications and/or gaming data, for example in database 352. For example, as shown in FIG. 3B, social gaming server 350 may include a social “Game A” application 357. The gaming applications may be provided by a cloud service 354 for access by one or more electronic devices 356. The electronic devices 356 may include mobile devices, tablets, mobile phones, wearable devices, personal computers, home gaming devices, or the like, or some combination thereof. Online gaming server 350 may manage user data and game assets for the games, such as rewards, points, virtual tokens, or the like. The values may be in one or more currencies or other measurements, which may be specific to a particular game, suite of games, platform, or the like. In some embodiments, social gaming server 350 may interface with other devices using cross-platform API 358, which may be used to make calls to CX Play server 312, in order to facilitate cross-platform gaming. As an example, a player on the social version of Game A 357 may engage in an interactive game with a play of a mobile version of Game A 321, hosted by CMS 320, and/or a player at an electronic gaming machine by way of EGM Game A module 323.

CX play cloud service 304 may support multiple types of online gaming. For example, online gaming server 360 may support a particular online game or suite of games which is different than the online game or suite of games hosted by online gaming server 350. In particular, online gaming server 360 may provide gameplay for online games over a cloud service 364, for example by hosting one or more gaming applications and/or gaming data, for example in database 362. The gaming applications, such as online “Game B” module 361 shown in FIG. 3B, may be provided by a cloud service 364 for access by one or more electronic devices 366. The electronic device 366 may include mobile devices, tablets, mobile phones, wearable devices, personal computers, home gaming devices, or the like, or some combination thereof. Online gaming server 360 may manage user data and game assets for the games, such as rewards, points, virtual tokens, or the like. The values may be in one or more currencies, which may be specific to a particular game, suite of games, platform, or the like, and which may differ from currencies used by online gaming server 350, and/or land based games such as those hosted by casino management system 320 or casino management system 330. In some embodiments, social gaming server 360 may interface with other devices using cross-platform API 363, which may be used to make calls to CX Play server 312, in order to facilitate cross-platform gaming and exchange of game assets. For example, a player on the online version of Game B 361 may engage in an interactive game session with a player of an EGM version of Game B module 334.

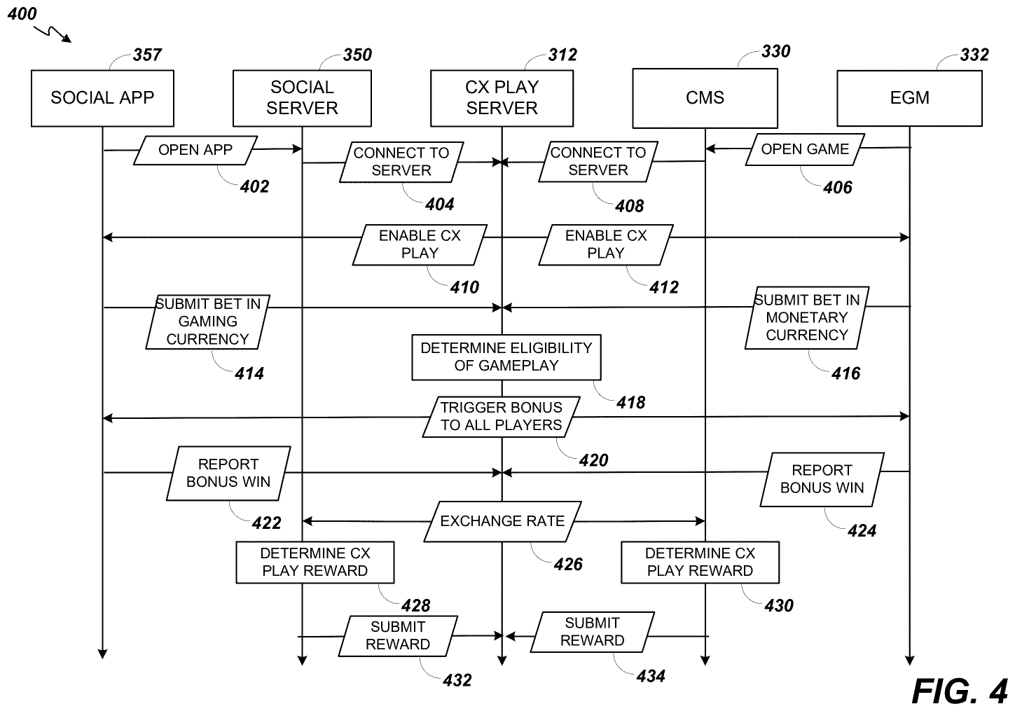

Turning to FIG. 4, a flow diagram 400 is presented of a technique for providing cross-platform gameplay, in accordance with one or more embodiments. For purposes of clarity, the flow diagram will be described with respect to the components of FIG. 3A-3B. In particular, the flow diagram 400 depicts example data flow managed by the cross-platform server, shown as CX Play server 312. In this example, cross-platform gameplay is performed between an online game and a land based game. To that end, social server 350 is depicted as facilitating gameplay from a mobile device 356. Similarly, casino management system 330 is depicted as facilitating gameplay from an electronic gaming machine 332. It should be understood that alternative components may be used. Further, the particular data flow is one example of the technique for enabling cross-platform gameplay. In some embodiments, not all processes may be performed, some additional processes may be needed, or some may be performed in parallel.

The flow diagram begins with a player at mobile device 356 opening the application 357 from the social server 350. In order to facilitate cross-platform gameplay, the social server 350 connects to the CX play server 312 at block 404. Similarly, a player at EGM 332 can access a game 406 using the CMS 330. In order to facilitate cross-platform gameplay, CMS 330 connects to CX play server 312 at block 408.

CX Play server 312 facilitates communication and gameplay between the social app 356 and the EGM 332 by determining that the social app 356 and the EGM 332 are authorized to participate in cross-platform gameplay. If so, CX play server 312 enables cross-platform play at the social app 356, as shown at bock 610. In some embodiments, CX play server 312 may enable cross-platform play directly with the social app 356, or via the social server 350. Similarly, CX play server 312 enables cross-platform play at the EGM 332, as shown at bock 412. In some embodiments, CX play server 312 may enable cross-platform play directly with the EGM 332, or via the CMS 330. Further, in some embodiments, linked players can see what other players are doing. For example, linked players may see online friends win, learning how bonuses work, or learn about new games by watching the gameplay of others.

According to some embodiments, the cross-platform play may include a game in which the player at the social app 356 and the player at the EGM 332 may play together within a multi-platform gameplay session. For example, the social app 356 may include game features which are provided to EGM 332, or social app 356 may enable features similar to those provided at EGM 332. As another example, the cross-platform gameplay may include ancillary gameplay hosted by the CX play server 312.

In some embodiments, a player at the social app 356 may submit a bet at block 414 in a gaming currency specific to the social app 356, while the player at the EGM 332 may submit a bet at block 416 in a monetary currency or other currency different than the gaming currency. In the case where the cross-platform gameplay is an interactive game, the bets may be submitted to the CX play server 312 for the gameplay.

According to one or more embodiments, the cross-platform play server 312 may determine an eligibility of a bonus to each of the players, as shown at block 418. In the bonus, players can earn credit in the form of a universal currency, which can be redeemed for cash, social credits, or game-specific currency. The universal currency credit may be earned in addition to, or alternatively to, credits earned in the native game, such as the social app 356 and/or the EGM 332. Thus, in addition to earning what a player would normally earn in a game, the player may also receive credit in the form of the universal currency, for even more entertainment. To that end, the bet submitted at block 414 and/or the bet submitted at block 416 may include a portion of the bet in a native currency, as well as a portion of the bet in the universal currency.

In some embodiments, the bonus feature may have interactive elements. For example, users may see each other, talk to each other, and play the same bonus game. Examples of the bonus game include a free spin bonus, a wheel-based game, a picking game, or the like. In some embodiments, the bonus game may facilitate collaboration or competition among players.

Communication between the players may be facilitated by the CX play server 312. In some embodiments, a level of collaboration may influence a reward. For example, a collection mechanic, a democratized picking game, a skill-based mechanic, and the like may be implemented in the form of the bonus feature. Alternatively, the bonus feature could pin players against each other where players at the top of a leaderboard are rewarded more than players at the bottom. Players can get on the leaderboard by collecting objects, making the right choices, or beating other players in games of skill.

According to some embodiments, all players participating in the bonus feature may be rewarded based on an outcome of the bonus feature. For example, as shown at block 422, social app 356 may report a win. Similarly, at block 424, EGM 332 may also report a win. To determine the bonus value in each currency (i.e., social app currency, EGM currency, and universal currency), the CX play server 312 may determine the exchange rate 426 for each of the different currency combinations. In some embodiments, the CX play server 312 may determine the corresponding wins for each player. For example, a win may be determined based on a contribution of a particular player in a cooperative game. Alternatively, as shown at 426, the exchange rate may be shared with the social server 350 and the CMS 430 such that each system can determine a win value.

As an example, a bonus may pay out 25X plus 400,000 in universal currency. The CMS 330 may determine the cross-platform play reward 430 from the bonus game based on the exchange rate. As an example, a land-based player at EGM 332 betting $1.00 would get $25.00, plus 400,000 in universal currency. Meanwhile, the social server 350 may determine the cross-platform play reward at block 428. For example, an online player at social app 356 may bet 100,000 in social gaming coins, resulting in a winning of 2,500,000 social gaming coins, plus 500,000 in universal currency. In some embodiments, the return to player in the native currency and the universal currency may differ across different platforms. The CMS 330 may then submit the reward at block 434 to CX play server 312. Similarly, social server 350 may submit the reward at block 432 to CX play server 312. In some embodiments, the CX play server may store the reward information with the corresponding player accounts.

According to one or more embodiments, players can interact in cross-platform gameplay in a number of ways. Example cross-platform gameplay modes include every player for themselves, where any player can win or lose. In this gameplay mode, various potential win or loss combinations may occur between players such that one player's win or loss does not affect the win or loss of another player. Another example cross-platform gameplay mode includes teamed gameplay, in which two or more players in a cross-platform gameplay session either win or lose together. Another example cross-platform gameplay mode includes vs. mode, in which a one player wins and another one or more loses. Similarly, in a team gameplay mode, a team of players may win while another team loses.

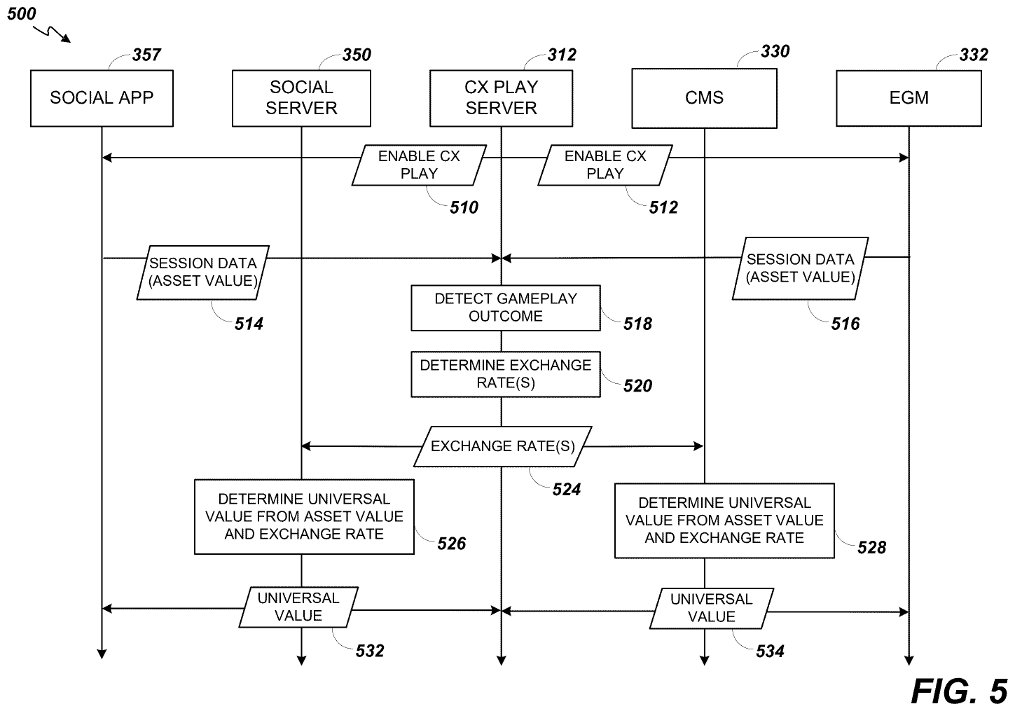

FIG. 5 shows a flow diagram 500 of a technique for providing cross-platform gameplay, in accordance with one or more embodiments. For purposes of clarity, the flow diagram will be described with respect to the components of FIG. 3A-3B. In particular, the flow diagram 500 depicts example data flow managed by the cross-platform server, shown as CX Play server 312. In this example, cross-platform gameplay is performed between an online game and a land based game. To that end, social server 350 is depicted as facilitating gameplay from a mobile device 356. Similarly, casino management system 330 is depicted as facilitating gameplay from an electronic gaming machine 332. It should be understood that alternative components may be used. Further, the particular data flow is one example of the technique for enabling cross-platform gameplay. In some embodiments, not all processes may be performed, some additional processes may be needed, or some may be performed in parallel.

The flow diagram begins with a player at mobile device 356 opening the social application 357 from the social server 350. CX Play server 312 facilitates communication and gameplay between the social app 356 and the EGM 332 by enabling cross-platform play at the social app 356, as shown at bock 510. In some embodiments, CX play server 312 may enable cross-platform play directly with the social app 356, or via the social server 350. Similarly, CX play server 312 enables cross-platform play at the EGM 332, as shown at bock 512. In some embodiments, CX play server 312 may enable cross-platform play directly with the EGM 332, or via the CMS 330. Further, in some embodiments, linked players can see what other players are doing. For example, linked players may see online friends win, learning how bonuses work, or learn about new games by watching the gameplay of others.

At block 512, the social app 356 and/or social server 350 may transmit session data for the gaming session to the CX play server 312. According to some embodiments, the payload contains a second value that quantifies the second platform-specific asset implicated in the same gameplay event, thereby enabling synchronized cross-platform gameplay by the CX play server 312. In some embodiments, the payload may include an indication of a current value of a game asset, such as game credit, monetary value, current game awards or opportunities, and the like. Similarly, at block 514, the EGM 332, through the CMS 330, may transmit session data to the CX play server 312. Although the EGM and the social app may be engaged in a common cross-platform game, a resulting value of game assets may differ across the platforms. In some embodiments, the differing values may be apparent during the cross-platform gaming session. Alternatively, the values at the different platforms may be tracked and provided, for example, after the cross-platform gaming session concludes.

The flow diagram 500 proceeds to block 518, where the CX Play server 312 monitors correlated event streams from both platforms and detects that a common gameplay outcome relevant to both the first user and the second user has occurred. Examples of a game outcome may include completion of a shared bonus game or triggering of a cooperative feature, detection of a termination of a gaming session, detection of a jackpot win, and the like. The flow diagram 500 then proceeds to block 520, where the CX Play server 312 performs an exchange-rate determination routine. In some embodiments, the server queries the asset exchange data structure to obtain a first conversion rate that translates the first platform-specific asset into a universal-asset denomination, and a second conversion rate that performs the analogous translation for the second platform-specific asset. The rates may be coin-based rates or other monetary rates, reward rates, analogous opportunities such as free spins or feature games, or the like. In some embodiments, a single exchange rate may be determined between the platform-specific asset values for the social app 357 and the EGM 332. In some embodiments, a separate exchange rate for the platform-specific asset for the social app 357 to the universal asset value, and an exchange rate for he platform-specific asset for the EGM 332 to the universal asset value may be determined. At block 524, the exchange rate(s) are transmitted to the social server 350 and the CMS 330.

The flowchart proceeds to blocks 526 and 528. At block 526, the social server 350 uses the exchange rate(s) 524 to determine a universal value from the asset value for the platform-specific asset from the social app 357. Similarly, at block 528, the CMS 330 uses the exchange rate(s) 524 to determine a universal value from the asset value for the platform-specific asset for the EGM 332. In some embodiments, the universal value of the social app asset and the universal value of the EGM asset may be the same, or may differ. The flow diagram 500 concludes at block 532, where the social server 350 transmits the universal value for the social app asset to the social app 357 and/or the CX Play server 312. Similarly, the flow diagram 500 also concludes at block 534, where the CMS 330 transmits the universal value for the EGM asset to the EGM 332 and/or the CX Play server 312.

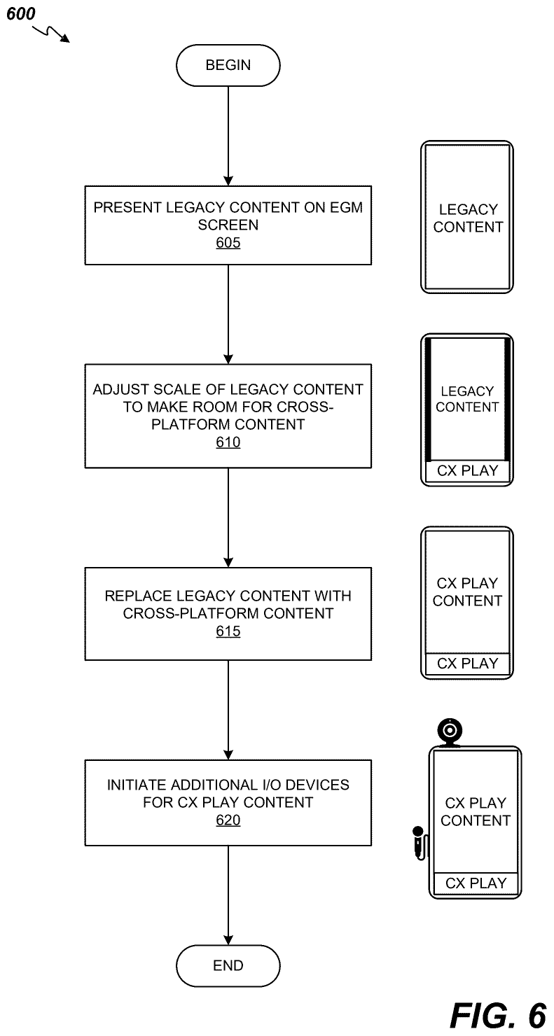

FIG. 6 is a flowchart of a technique for initiating cross-platform gameplay on an electronic gaming machine, according to some embodiments. In some embodiments, the cross-platform feature may be an ancillary gameplay feature to a native game on an electronic gaming machine (i.e., games that can be played outside the cross-platform feature). Thus, the presentation of native games on an electronic gaming machine may be adjusted to allow room for presentation of cross-platform content. For purposes of clarity, the flowchart will be described with respect to the components of FIG. 3. However, it should be understood that alternative components may be used. Further, the various processes of the flowchart may be performed in an alternative order. In some embodiments, not all processes may be performed, or some may be performed in parallel.

The flowchart begins at block 605, where legacy content is presented on an EGM screen. That is, content that is related to a game played on an EGM supported by a CMS is considered a legacy game, whereas cross-platform features or games are not considered legacy games. To begin, the legacy content is presented in a native scale, for example taking up an entire display region of a screen of the EGM.

Turning to block 610, a scale of the legacy content is adjusted to make room for the cross-platform data. In the example shown, the initial cross platform data includes a banner indicating that cross-platform functionality is available. However, the cross platform data may be presented in a variety of ways and on any other portion of the screen. In this example, the dimensions of the legacy content are reduced, but the proportions of the dimensions remain the same.

At block 615, the legacy content is replaced with cross-platform content. The cross-platform content may include a cross-platform game which may be a different game than the legacy game. As another example, the cross-platform content may correspond to a cross-platform variation of the legacy game. The cross-platform content may correspond to cross-platform gameplay.

The flowchart concludes at block 620, where additional I/O device are initiated for cross-platform content. For example, a microphone and/or camera may be initiated which can be used by the cross-platform features to enable a local user to communicate with remote users. The particular I/O devices enabled may be selected based on capabilities of the cross-platform functionality of the cross-platform content.

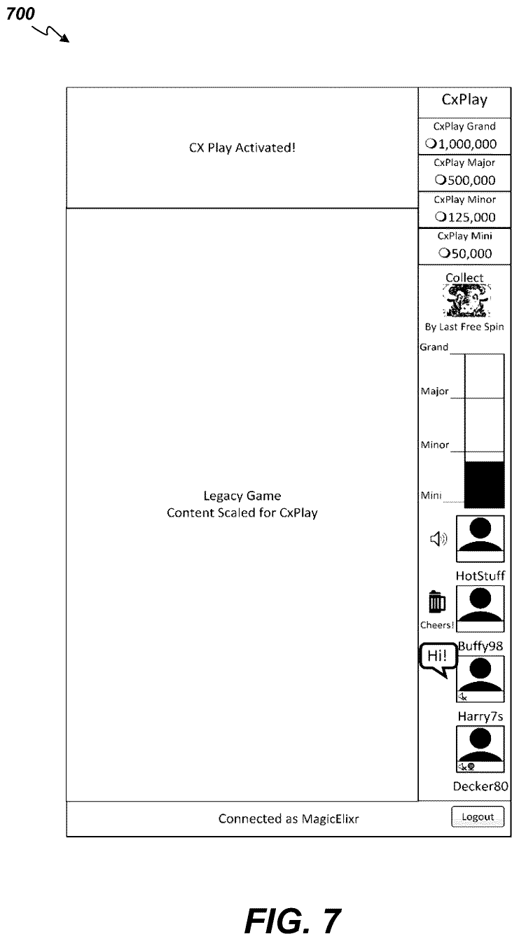

FIG. 7 shows an example cross-platform interface 700 on an EGM, according to some embodiments. In this example, the cross-platform data is presented in the form of banners surrounding the legacy game content, which has been scaled for cross-platform gameplay. The cross-platform data may include a display portion for presenting visual representations of other connected players. In some embodiments, the players can interact with each other by voice, text, video, and the like. Messages and other media may be presented or indicated in the display portion. The cross-platform data may indicate cross-platform gaming features, such as a cross-platform game mechanic available, such as the free spin game identified by the buffalo. Further, the cross-platform features may be associated with cross-platform specific jackpots, which are identified in the cross-platform data.

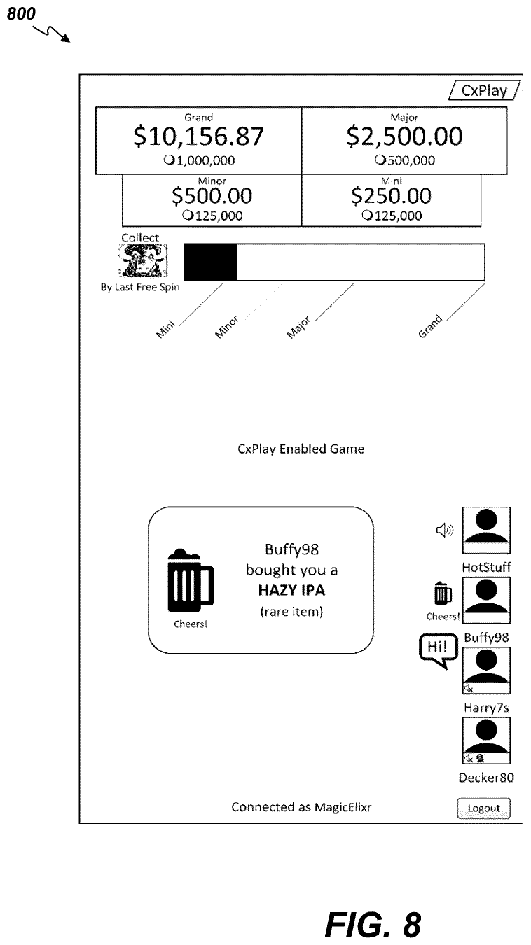

FIG. 8 shows an alternative example cross-platform interface 800 on an EGM, according to some embodiments. In this example, the cross-platform content is presented in place of the legacy game content. In this example, the CX play content can better utilize the space for communicating messages and enabling features as compared to the legacy game. As an example, if a gift is received from another player connected in the cross-platform system, a pop-up overlay appears. Further, the portion of the display showing the jackpot information is configured to present the jackpot award in a native currency (i.e., a currency associated with the legacy game), and the universal currency.

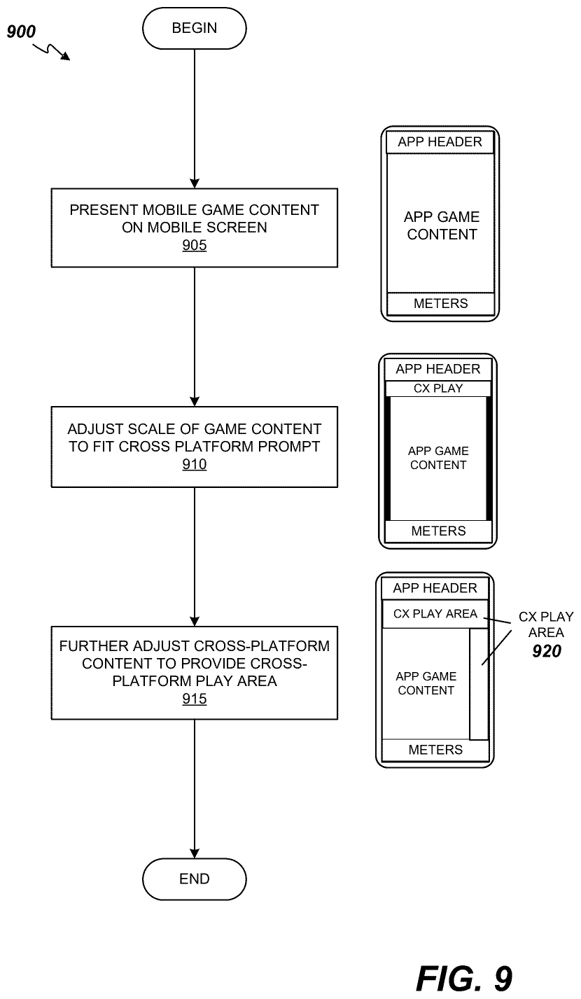

FIG. 9 is a flowchart of a technique for initiating cross-platform gameplay on a mobile application, according to some embodiments. In some embodiments, the cross-platform feature may be an ancillary gameplay feature to a native mobile game (i.e., games that can be played outside the cross-platform feature). Thus, the presentation of native games on an electronic gaming machine may be adjusted to allow room for presentation of cross-platform content. For purposes of clarity, the flowchart will be described with respect to the components of FIG. 3. However, it should be understood that alternative components may be used. Further, the various processes of the flowchart may be performed in an alternative order. In some embodiments, not all processes may be performed, or some may be performed in parallel.

The flowchart begins at block 905, where mobile game content is presented on a mobile screen. In this example, the mobile game content includes app game content, as well as an ap header, and meters for the game. The app game content is presented in a native scale. For purposes of this example, the app game content is presented in a portrait-style mode. However, in some embodiments, the app game content may be presented in a landscape or other layout.

The flowchart proceeds to block 910, where the scale of the game content is adjusted to fit the cross-platform prompt. In some embodiments, the cross-platform prompt may be presented in response to the application being connected to the cross-platform play server. In the example shown, the cross-platform prompt includes a banner indicating that cross-platform functionality is available. However, the cross-platform prompt may be presented in a variety of ways and on any other portion of the screen. In this example, the dimensions of the app game content are reduced, but the proportions of the dimensions remain the same.

The flowchart concludes at block 915, where upon initiating a cross-platform feature, the app game content is presented along with cross-platform content. The cross-platform content may include a cross-platform game which may be a different game than the app game. In this example, the app game content is further reduced to make room for a cross-platform play area. The cross-platform play area 920 may be used to present features that allow interactive gameplay among users of the cross-platform features. In some embodiments, the cross-platform play area may be used to present persistent cross-platform play features concurrently with the app game content.

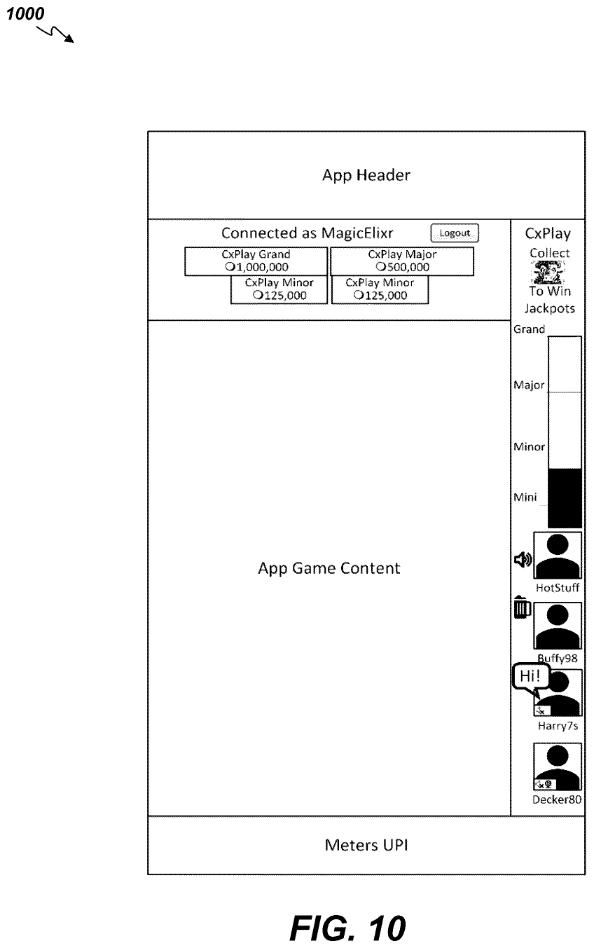

FIG. 10 shows an example cross-platform interface 1000 on a mobile application, according to some embodiments. The app header may include the player's account information and balance. Although the app header is shown at the top of the interface, in some embodiments the app header may be presented on the bottom or along the side of the interface. The credit meter, win meter, and bet buttons are shown at the bottom of the interface, with the game content presented in the middle. However, the specific layout of the interface may differ. The cross-platform play area is depicted as interface components between the app game content and the app header, and along one side of the interface. In this example, the cross-platform play area shows similar components to those described above in the cross-platform play content on the EGM as shown in FIG. 7.

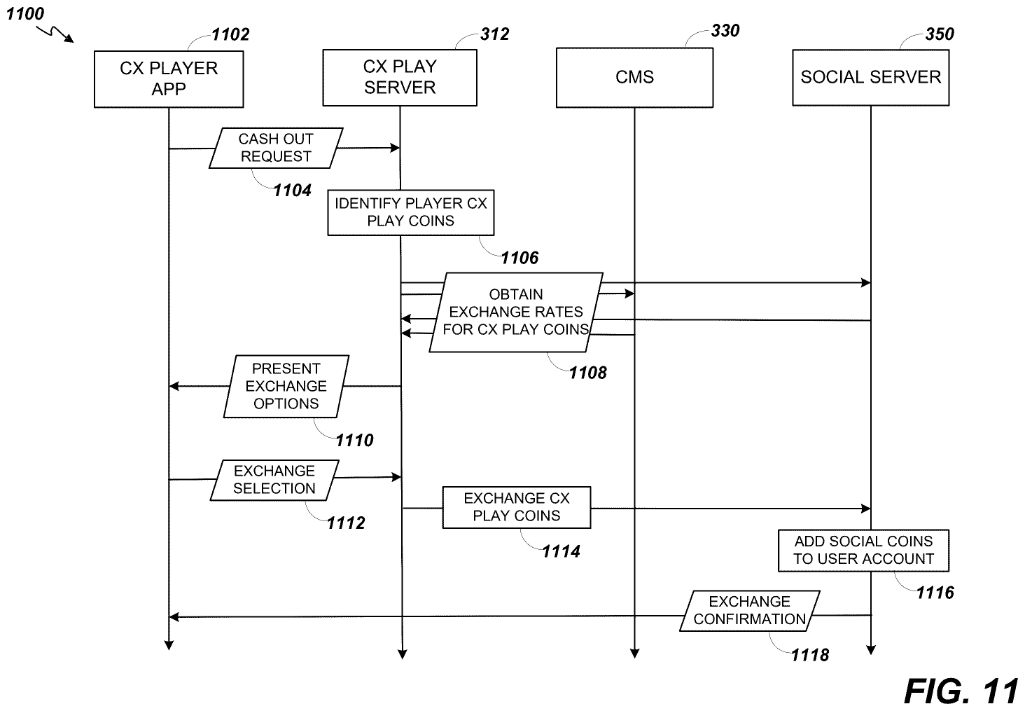

FIG. 11 depicts a flow diagram of a technique for cashing out cross-platform credit in order to receive the credit in a different currency, according to some embodiments. For purposes of clarity, the flowchart will be described with respect to the components of FIG. 3. However, it should be understood that alternative components may be used. Further, the various processes of the flowchart may be performed in an alternative order. In some embodiments, not all processes may be performed, or some may be performed in parallel. For purposes of clarity, the flowchart will be described with respect to the components of FIG. 3. However, it should be understood that alternative components may be used. Further, the various processes of the flowchart may be performed in an alternative order. In some embodiments, not all processes may be performed, or some may be performed in parallel.

The flow diagram 1100 begins with a user at a cross-platform player application 1102 submitting a cash out request 1104 to the CX play server 312. In some embodiments, the CX player app 1102 may be any gaming application communicably connected to the CX player server 312, such as a mobile gaming app, a land-based game, such as on an EGM in a casino, or the like. The cash out request may indicate that the user wishes to trade their credit from the universal currency to a different currency. At 1106, the CX play server 312 identifies the player CX credit. In some embodiments, the CX play server 312 identifies the player from a database or other datastore of players, for example based on a user name or other identifier.

The CX play server 312 determines exchange rates for each of a set of candidate currencies. This may include, as shown at 1108, obtaining exchange rates from different ecosystems for the universal currency. In some embodiments, the CX player 312 may request exchange rates from other servers and systems, such as CMS 330 and/or social server 350. The CMS 330 and social server 350 may provide exchange rates directly from their native currencies to the universal currency. As another example, the CMS 330 and/or social server 350 may provide a current value of their native currencies in another manner, such as in comparison to a dollar or other currency which is known to the CX play server 312.

The flow diagram 1100 proceeds to the CX play server 312 determining potential target currencies and values based on the exchange rates and presenting the exchange options to the player at 1110. This may include, for example, an indication of the value and currency or application or game platform to which the currency belongs. For example, candidate rewards may be provided to the user. At 1112, the player may make a selection from the candidate exchanges.

For purposes of this example, the selected exchange may be a mobile game currency. Thus, at 1114 the CX play sever 312 performs a transaction with the social server 350 to sell the current CX play coin value to the mobile game currency. Then, at 1116, the social server 350 adds the social coins, or the value in the mobile game currency, to a user account for the social server. The flow diagram 1100 concludes with the social server 350 providing an exchange confirmation 1118 to the player.

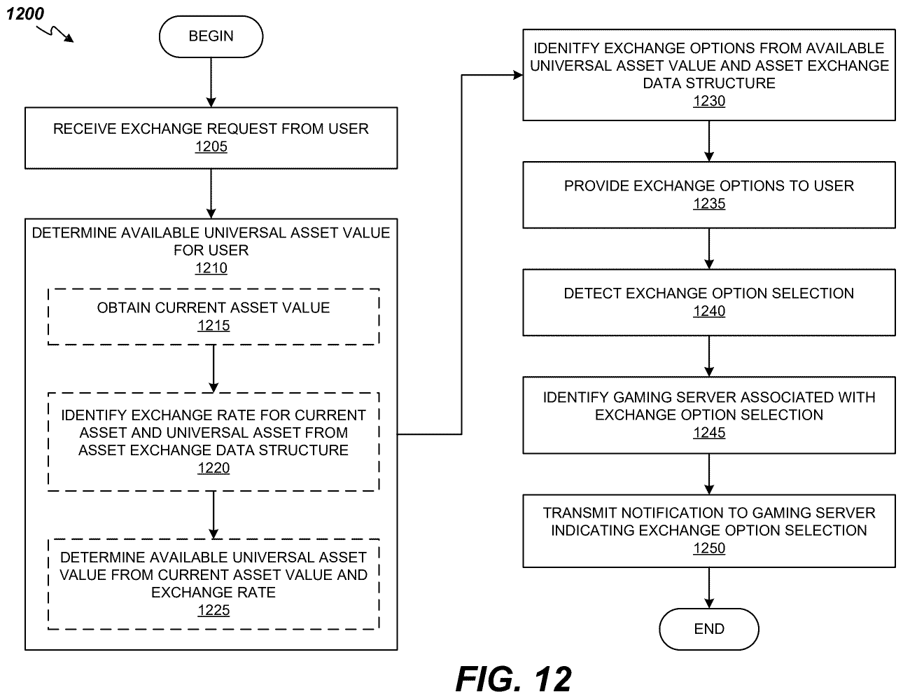

FIG. 12 depicts a flowchart of a technique for exchanging game assets using the cross-platform system, in accordance with one or more embodiments. For example, a user may utilize a marketplace or other exchange platform hosted by the CX Play server 312 to exchange a current asset associated with a particular game and/or platform, to another asset associated with a different particular game and/or a different particular platform. For purposes of clarity, the flowchart will be described with respect to the components of FIG. 3. However, it should be understood that alternative components may be used. Further, the various processes of the flowchart may be performed in an alternative order. In some embodiments, not all processes may be performed, or some may be performed in parallel.

The flowchart 1200 begins at block 1205, where the CX Play Server 312 receives, via a first instance of the multi-platform gaming API executing on a client device, an exchange request initiated by a player. The request may include the player identifier, session identifier, and/or one or more parameters indicating that the player is invoking an exchange function. Upon receipt, the CX Play Server 312 may authenticate the request against the player-tracking system server 110 to verify identity and entitlement before continuing.

The flowchart proceeds to block 1210, where an available universal asset value is determined for the user. In some embodiments, the available universal asset value may be based on a total availability of assets for the user, or may be calculated based on a current asset value. Thus, at optional block 1215, the CX Play server obtains a current asset value. The current asset value may be identified in the request, or may be identified based on a user profile store. The flowchart 1200 then proceeds to optional block 1220, where an exchange rate is identified for the current asset and the universal asset from the asset exchange data structure. As described above the asset exchange data structure may maintain a dynamic mapping of exchange rates between monetary and non-monetary platform-specific assets to a universal asset. Then, at optional block 1225, the available universal asset value can be determined from the current asset value and the exchange rate.

At block 1230, the CX Play server identifies exchange options from the available universal asset value and asset exchange data structure. In some embodiments, the CX Play server identifies target assets for exchange based on the available universal asset value for the user. For example, the CX Play server can perform a lookup in the asset exchange data structure to determine assets for other games and/or platforms to which the available universal asset value can be exchanged. Such target assets may include credits, coins, bonus spins, feature games, and the like.

The flowchart 1200 proceeds to block 1235, where the exchange options are provided to the user. Here, the player can review a range of available choices for converting their universal asset value into various platform-specific assets or rewards, such as credits, coins, bonus spins, or special features across different games or platforms. The interface may display information for each option, including the asset type, asset quantity, corresponding platform, exchange rates, and the resulting value after conversion, and the like.

At block 1240, the CX Play server detects an exchange option selection. Then, at block 1245, a gaming server associated with the selected exchange option is identified. In some embodiments, the CX Play server may identify the gaming server based on destination metadata stored in the asset exchange data structure. Example potential gaming servers include, but are not limited to, a casino management system, a social gaming server, a mobile gaming server, or the like.

The flowchart 1200 concludes at block 1250, where the CX Play Server 312 constructs a notification message that includes the player identifier, the asset type, the asset quantity, and the like. Upon receipt, the destination gaming server credits the player's account with the exchanged asset and returns an acknowledgment. In some embodiments, the acknowledgment triggers the CX Play Server 312 to finalize the debit of the reserved universal asset amount and to generate an audit log entry in the data collection system 150.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A method comprising:
initiating a multi-platform gaming session of an electronic game between a first user from a first platform electronic device and a second user from a second platform electronic device;
receiving, from a first platform version of the electronic game on the first platform electronic device, first session data comprising a first value associated with a first platform-specific asset, wherein the first session data is packaged at the first platform electronic device by a first instance of a multi-platform gaming application program interface (API);
receiving, from the second platform electronic device, second session data comprising a second value associated with a second platform-specific asset, wherein the second session data is packaged at the second platform electronic device by a second instance of the multi-platform gaming application program interface (API);
in response to a gameplay outcome in the multi-platform gaming session:
obtaining, from an asset exchange data structure, a first conversion rate for the first platform-specific asset to a universal asset,
obtaining, from the asset exchange data structure, a second conversion rate between the second platform-specific asset and the universal asset,
providing, by way of the first instance of the multi-platform gaming API, the first conversion rate to the first platform electronic device; and
providing, by way of the second instance of the multi-platform gaming API, the second conversion rate to the second platform electronic device; and
in response to receiving gameplay outcome data associated with the universal asset from the first platform electronic device, storing the outcome data in association with the first user.

2. The method of claim 1, wherein the first platform electronic device executes a mobile version of the electronic game, and wherein the second platform electronic device executes an electronic gaming machine version of the electronic game.

3. The method of claim 1, wherein the first platform electronic device comprises a first electronic gaming machine platform and wherein the second platform electronic device comprises a second electronic gaming machine platform.

4. The method of claim 1, further comprising:
launching a bonus game for the first user on the first platform and a second user on the second platform, wherein the bonus game is configured to facilitate interaction between the first user and the second user, and
wherein the gameplay outcome is based on an outcome of the bonus game.

5. The method of claim 4, wherein the gameplay outcome is based on at least one selected from a group consisting of: a relative contribution of the first user and the second user, and wager data.

6. The method of claim 1, further comprising:
receive an exchange request from the first user;
identify an available value for the first user for the universal asset;
determine a plurality of candidate exchange options based on the available value and the asset exchange data structure;
in response to receiving a selection of a first candidate exchange option:
transmitting a notification to a gaming server associated with the first candidate exchange option, wherein the notification indicates the first candidate exchange option.

7. The method of claim 6, wherein the plurality of exchange options comprises at least one selected from a group consisting of a game asset, a game bonus, and a game credit.

8. A non-transitory computer readable medium comprising computer readable code executable by one or more processors to:
initiate a multi-platform gaming session of an electronic game between a first user from a first platform electronic device and a second user from a second platform electronic device;
receive, from a first platform version of the electronic game on the first platform electronic device, first session data comprising a first value associated with a first platform-specific asset, wherein the first session data is packaged at the first platform electronic device by a first instance of a multi-platform gaming application program interface (API);
receive, from the second platform electronic device, second session data comprising a second value associated with a second platform-specific asset, wherein the second session data is packaged at the second platform electronic device by a second instance of the multi-platform gaming application program interface (API);
in response to a gameplay outcome in the multi-platform gaming session:
obtain, from an asset exchange data structure, a first conversion rate for the first platform-specific asset to a universal asset,
obtain, from the asset exchange data structure, a second conversion rate between the second platform-specific asset and the universal asset,
provide, by way of the first instance of the multi-platform gaming API, the first conversion rate to the first platform electronic device, and
provide, by way of the second instance of the multi-platform gaming API, the second conversion rate to the second platform electronic device; and
in response to receiving gameplay outcome data associated with the universal asset from the first platform electronic device, store the outcome data in association with the first user.

9. The non-transitory computer readable medium of claim 8, wherein the first platform electronic device executes a mobile version of the electronic game, and wherein the second platform electronic device executes an electronic gaming machine version of the electronic game.

10. The non-transitory computer readable medium of claim 8, wherein the first platform electronic device comprises a first electronic gaming machine platform and wherein the second platform electronic device comprises a second electronic gaming machine platform.

11. The non-transitory computer readable medium of claim 8, further comprising computer readable code to:
launch a bonus game for the first user on the first platform and a second user on the second platform, wherein the bonus game is configured to facilitate interaction between the first user and the second user, and
wherein the gameplay outcome is based on an outcome of the bonus game.

12. The non-transitory computer readable medium of claim 11, wherein the gameplay outcome is based on at least one selected from a group consisting of: a relative contribution of the first user and the second user, and wager data.

13. The non-transitory computer readable medium of claim 8, further comprising computer readable code to:
receive an exchange request from the first user;
identify an available value for the first user for the universal asset;
determine a plurality of candidate exchange options based on the available value and the asset exchange data structure;
in response to receiving a selection of a first candidate exchange option:
transmitting a notification to a gaming server associated with the first candidate exchange option, wherein the notification indicates the first candidate exchange option.

14. The non-transitory computer readable medium of claim 13, wherein the plurality of exchange options comprises at least one selected from a group consisting of a game asset, a game bonus, and a game credit.

15. A system comprising:
one or more processor; and
one or more computer readable media comprising computer readable code executable by one or more processors to:
initiate a multi-platform gaming session of an electronic game between a first user from a first platform electronic device and a second user from a second platform electronic device;
receive, from a first platform version of the electronic game on the first platform electronic device, first session data comprising a first value associated with a first platform-specific asset, wherein the first session data is packaged at the first platform electronic device by a first instance of a multi-platform gaming application program interface (API);
receive, from the second platform electronic device, second session data comprising a second value associated with a second platform-specific asset, wherein the second session data is packaged at the second platform electronic device by a second instance of the multi-platform gaming application program interface (API);
in response to a gameplay outcome in the multi-platform gaming session:
obtain, from an asset exchange data structure, a first conversion rate for the first platform-specific asset to a universal asset,
obtain, from the asset exchange data structure, a second conversion rate between the second platform-specific asset and the universal asset,
provide, by way of the first instance of the multi-platform gaming API, the first conversion rate to the first platform electronic device, and
provide, by way of the second instance of the multi-platform gaming API, the second conversion rate to the second platform electronic device; and
in response to receiving gameplay outcome data associated with the universal asset from the first platform electronic device, store the outcome data in association with the first user.

16. The system of claim 15, wherein the first platform electronic device executes a mobile version of the electronic game, and wherein the second platform electronic device executes an electronic gaming machine version of the electronic game.

17. The system of claim 15, wherein the first platform electronic device comprises a first electronic gaming machine platform and wherein the second platform electronic device comprises a second electronic gaming machine platform.

18. The system of claim 15, further comprising computer readable code to:
launch a bonus game for the first user on the first platform and a second user on the second platform, wherein the bonus game is configured to facilitate interaction between the first user and the second user, and
wherein the gameplay outcome is based on an outcome of the bonus game.

19. The system of claim 15, further comprising computer readable code to:
receive an exchange request from the first user;
identify an available value for the first user for the universal asset;
determine a plurality of candidate exchange options based on the available value and the asset exchange data structure;
in response to receiving a selection of a first candidate exchange option:
transmitting a notification to a gaming server associated with the first candidate exchange option, wherein the notification indicates the first candidate exchange option.

20. The system of claim 19, wherein the plurality of exchange options comprises at least one selected from a group consisting of a game asset, a game bonus, and a game credit.
